(19) United States
(12) Patent Application Publication
(10) Pub. No.: US 2012/0218682 A1
(43) Pub. Date: Aug. 30, 2012

(54) SOLID ELECTROLYTIC CAPACITOR AND MANUFACTURING METHOD THEREOF

(75) Inventors: Keiichi KOMATSU, Hirakata-city (JP); Koichi NISHIMURA, Kadoma-city (JP); Fumio TATEZONO, Hirakata-city (JP)

(73) Assignee: SANYO Electric Co., Ltd., Moriguchi-city (JP)

(21) Appl. No.: 13/403,879

(22) Filed: Feb. 23, 2012

(30) Foreign Application Priority Data
Feb. 24, 2011 (JP) 2011-038601
Jan. 20, 2012 (JP) 2012-009607

(51) Int. Cl. H01G 9/15; H01G 9/00

(52) U.S. Cl. 361/523; 29/25.03

(57) ABSTRACT

A solid electrolytic capacitor including an anode, a dielectric layer formed on the anode, a polyvinyl alcohol film formed on the dielectric layer, and a conductive polymer layer formed on the polyvinyl alcohol film, wherein the polyvinyl alcohol film has a cross-linked structure.

### BACKGROUND OF THE INVENTION

1. Field of the Invention

This invention relates to solid electrolytic capacitors and methods for manufacturing the same.

2. Description of Related Arts

With the recent trend toward diversification and greater functionality of electronic devices including computers and mobile terminals, solid electrolytic capacitors for use in their electronic circuits are being required to reduce power consumption and have higher withstand voltage.

Conventionally, a solid electrolytic capacitor has a dielectric layer formed between an anode and a cathode by anodizing the anode. The dielectric layer may form defects, such as cracks, during the anodization or in later steps. To reduce the power consumption of the solid electrolytic capacitor, it is necessary to reduce the leakage current flowing between the anode and cathode via defects or the like in the dielectric layer. On the other hand, to give the solid electrolytic capacitor a higher withstand voltage, it is necessary to increase the withstand voltage by preventing breakage of the dielectric layer which may be caused by defects or the like in the dielectric layer.

To meet these requirements, JP-A-2007-173454 proposes a technique in which a solid layer for supplying oxygen upon voltage application is provided on the surface of a dielectric layer of a solid electrolytic capacitor to repair defects in the dielectric layer. In Example 4 of JPA-2007-173454, a solid layer made of polyvinyl alcohol is formed.

### SUMMARY OF THE INVENTION

However, even if a polyvinyl alcohol film is formed on the dielectric layer in accordance with the method disclosed in the above related art, the effect of reducing the leakage current and the effect of increasing the withstand voltage cannot be sufficiently achieved.

An object of the present invention is to provide a solid electrolytic capacitor having a small leakage current and a high withstand voltage and a method for manufacturing the same.

In a first aspect of the present invention, a solid electrolytic capacitor includes an anode, a dielectric layer formed on the anode, a polyvinyl alcohol film formed on the dielectric layer, and a conductive polymer layer formed on the polyvinyl alcohol film, wherein the polyvinyl alcohol film has a cross-linked structure.

The solid electrolytic capacitor according to the above aspect of the present invention can reduce the leakage current and increase the withstand voltage.

In the above aspect of the present invention, the cross-linked structure of the polyvinyl alcohol film can be formed by a cross-linking agent having, for example, at least two aldehyde groups, at least two hydroxyl groups, or at least two carboxyl groups.

An example of the cross-linking agent is glutaraldehyde.

The thickness of the polyvinyl alcohol film in the above aspect of the present invention is preferably within the range of 5 to 20 nm.

The polyvinyl alcohol film may contain a second conductive polymer separate from a first conductive polymer forming the conductive polymer layer. In this case, an example of the second conductive polymer is polypyrrole.

A manufacturing method in a second aspect of the present invention is a method for manufacturing the solid electrolytic capacitor according to the first aspect of the present invention, and includes the steps of: producing the anode; forming the dielectric layer on the anode; immersing the anode with the dielectric layer formed thereon into a solution of polyvinyl alcohol to allow polyvinyl alcohol to adhere to the dielectric layer; after the adhesion of the polyvinyl alcohol, immersing the anode into a solution containing a cross-linking agent to cross-link the polyvinyl alcohol and thereby form the polyvinyl alcohol film having a cross-linked structure on the dielectric layer; and forming the conductive polymer layer on the polyvinyl alcohol film.

With the use of the manufacturing method according to the second aspect of the present invention, a solid electrolytic capacitor having a small leakage current and a high withstand voltage can be efficiently manufactured.

In manufacturing the solid electrolytic capacitor in which the polyvinyl alcohol film contains the second conductive polymer, the manufacturing method preferably further includes the steps of: after the formation of the polyvinyl alcohol film, immersing the anode into a liquid containing a monomer of the second conductive polymer to allow the polyvinyl alcohol film to contain the monomer; and after the inclusion of the monomer in the polyvinyl alcohol film, immersing the anode into a solution of oxidizing agent to polymerize the monomer in the polyvinyl alcohol film and thereby form the second conductive polymer.

In the manufacturing method according to the second aspect of the present invention, the concentration of the solution of polyvinyl alcohol is preferably within the range of 0.05% to 0.2% by mass.

Hence, the solid electrolytic capacitor according to the present invention can reduce the leakage current and have a high withstand voltage.

With the use of the manufacturing method according to the present invention, a solid electrolytic capacitor having a small leakage current and a high withstand voltage can be efficiently manufactured.

### BRIEF DESCRIPTION OF THE DRAWINGS

FIG. 1 is a schematic cross-sectional view showing a solid electrolytic capacitor of an embodiment of the present invention.

FIG. 2 is a schematic cross-sectional view showing in enlarged dimension the surface and adjacent region of an anode of the solid electrolytic capacitor shown in FIG. 1.

### DETAILED DESCRIPTION OF PREFERRED EMBODIMENTS

### First Embodiment

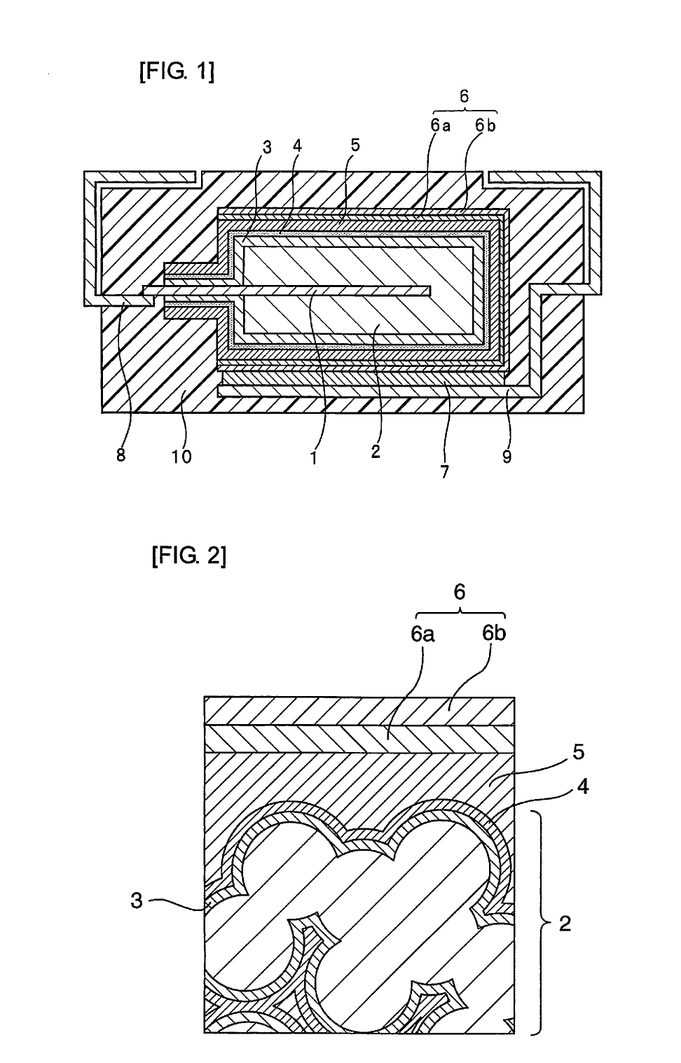

FIG. 1 is a schematic cross-sectional view showing a solid electrolytic capacitor of a first embodiment of the present invention.

As shown in FIG. 1, an anode lead 1 is embedded in an anode 2. The anode 2 is produced by forming a powder made of a valve metal or a valve metal-based alloy into a formed body and sintering the formed body. Therefore, the anode 2 is formed of a porous body. The porous body has a large number of fine pores formed to communicate between their insides and the outside, although they are not shown in FIG. 1. The anode 2 thus produced has, in this embodiment, the outer shape of an approximately rectangular box.

Although no particular limitation is placed on the type of valve metal forming the anode 2 so long as it can be used for a solid electrolytic capacitor, examples thereof include tantalum, niobium, titanium, aluminum, hafnium, zirconium, zinc, tungsten, bismuth, and antimony. Of these, the particularly preferred valve metals are tantalum, niobium, titanium, and aluminum because their oxides have high dielectric constants and their source materials are easily available. On the other hand, examples of valve metal-based alloys include alloys made of two or more valve metals, such as an alloy of tantalum and niobium, and alloys made of a valve metal and another type of metal. When an alloy of a valve metal and another type of metal is used, the proportion of the valve metal in the alloy is preferably 50 atomic percent or more.

Alternatively, the anode used may be formed of a sheet of valve metal foil or valve metal-based alloy foil. To increase the surface area of the anode, an etched sheet of valve metal foil or valve metal-based alloy foil, a roll of such foil, or stacked sheets of such foil may also be used. Further alternatively, there may be used an anode formed by sintering such a sheet of foil and a powder into a single piece.

A dielectric layer 3 is formed on the anode 2. The dielectric layer 3 is also formed on the surfaces of the pores in the anode 2. Note that FIG. 1 schematically shows the portion of the dielectric layer 3 formed on the outside surfaces of the anode 2, but does not show the above-described portions of the dielectric layer formed on the surfaces of the pores in the porous body. The dielectric layer 3 can be formed by oxidizing the surface of the anode 2 using an aqueous solution of phosphoric acid or the like, such as by anodization.

A polyvinyl alcohol film 4 is formed on the dielectric layer 3. In the present invention, the polyvinyl alcohol film 4 has a cross-linked structure. No particular limitation is placed on the method for forming the polyvinyl alcohol film 4 having a cross-linked structure, but, for example, it can be formed by immersing the anode with the dielectric layer formed thereon into a solution of polyvinyl alcohol to allow polyvinyl alcohol to adhere to the dielectric layer and then immersing the anode into a solution containing a cross-linking agent to cross-link the polyvinyl alcohol.

The concentration of polyvinyl alcohol in the solution of polyvinyl alcohol is preferably within the range of 0.01% to 1% by mass, more preferably within the range of 0.02% to 0.5% by mass, and still more preferably within the range of 0.05% to 0.2% by mass.

The cross-linked structure of the polyvinyl alcohol film can be formed, as described above, by reacting the polyvinyl alcohol film with the cross-linking agent. The cross-linked structure of the polyvinyl alcohol film can be formed generally by reacting the hydroxyl groups in the polyvinyl alcohol film with the functional groups of the cross-linking agent. Examples of the functional group reactable with the hydroxyl group of polyvinyl alcohol include aldehyde group, hydroxyl group, and carboxyl group. Therefore, examples of the cross-linking agent include chemical compounds having at least two aldehyde groups, at least two hydroxyl groups, or at least two carboxyl groups. Examples of cross-linking agents having at least two aldehyde groups include glutaraldehyde, malonaldehyde, succinaldehyde, adipaldehyde, and phthalaldehyde. Examples of cross-linking agents having at least two hydroxyl groups include boric acid, borate salt, ethylene glycol, propylene glycol, and glycerin. Examples of cross-linking agents having at least two carboxyl groups include oxalic acid, malonic acid, succinic acid, glutaric acid, adipic acid, and phthalic acid.

Of these cross-linking agents, the particularly preferred is glutaraldehyde because it can cause a cross-linking reaction at a relatively low temperature doing no damage to the dielectric layer.

The concentration of the cross-linking agent in the solution containing the cross-linking agent is preferably within the range of 0.001 to 10.0 M (mol/L), more preferably within the range of 0.1 to 3.0 M (mol/L), and still more preferably within the range of 0.5 to 1.0 M (mol/L).

Because polyvinyl alcohol can generally be dissolved in water, a solution of polyvinyl alcohol can generally be prepared as an aqueous solution.

When the cross-linking agent used is a water-soluble compound, such as glutaraldehyde, a solution containing the cross-linking agent can be prepared as an aqueous solution.

After polyvinyl alcohol is allowed to adhere to the dielectric layer, it is preferably dried. The preferred drying temperature is generally within the range of 80° C. to 100° C.

After the adhesion of polyvinyl alcohol to the surface of the dielectric layer, the anode is immersed into a solution containing the cross-linking agent to cross-link the polyvinyl alcohol. It is generally preferred to cross-link the polyvinyl alcohol by first immersing the anode into a solution containing the cross-linking agent to allow the cross-linking agent to adhere to the dried polyvinyl alcohol film and then cross-linking the polyvinyl alcohol. The reaction temperature for cross-linking is appropriately selected depending on the cross-linking agent used. When the cross-linking agent used is an aldehyde compound, such as glutaraldehyde, the reaction temperature is preferably within the range of 10° C. to 100° C. and more preferably within the range of 20° C. to 60° C.

When the cross-linking agent used is boric acid, the reaction temperature is preferably within the range of 120° C. to 250° C.

In the present invention, the thickness of the polyvinyl alcohol film 4 is, for example, preferably within the range of 1 to 100 nm, more preferably within the range of 2 to 50 nm, and still more preferably within the range of 5 to 20 nm. If the thickness of the polyvinyl alcohol film 4 is too small, the effect of reducing the leakage current and the effect of increasing the withstand voltage may not be sufficiently achieved. If the thickness of the polyvinyl alcohol film 4 is too large, the pores in the inside of the anode 2 may be closed by the polyvinyl alcohol film, so that in the process of formation of a polymerized film, the polymerized film may not be able to be formed in the pores in the inside of the anode 2. Thus, the capacitance characteristics of the capacitor may be deteriorated.

The existence of the cross-linked structure in the polyvinyl alcohol film 4 can be confirmed, such as by Fourier transform infrared spectroscopy (FTIR). For example, when glutaraldehyde is used as a cross-linking agent, the existence of the cross-linked structure can be confirmed by detecting the existence of —(CH₂)₃— bonds.

A conductive polymer layer 5 is formed on the polyvinyl alcohol film 4. Examples of the polymer forming the conductive polymer layer 5 include fluorene copolymers, polyvinyl carbazole, polyvinyl phenol, polyfluorene, polyfluorene derivatives, polyphenylene, polyphenylene derivatives, phenylene copolymers, poly(p-phenylenevinylene), poly(p-phenylenevinylene) derivatives, phenylenevinylene copolymers, polypyridine, polypyridine derivatives, and pyridine copolymers.

The conductive polymer layer 5 can be formed using a conventionally known process, such as gas-phase chemical polymerization or electrolytic oxidation polymerization. Examples of the material that can be used for the conductive polymer layer 5 include those conventionally used as materials for forming a conductive polymer layer of a solid electrolytic capacitor. Examples of those materials include polypyrrole, polythiophene, and polyethylenedioxythiophene, and these materials doped with a dopant are preferably used. When these materials are doped with a dopant, the resultant product can achieve a high electrical conductivity of about 0.1 to 1000 S/cm, for example. To reduce the ESR of the resultant capacitor, a material having a higher electrical conductivity is preferably used.

The conductive polymer layer 5 may have a structure in which a plurality of layers are stacked. For example, the structure may be such that a first conductive polymer layer is formed on the polyvinyl alcohol film 4 by chemical polymerization and a second conductive polymer layer is formed on the first conductive polymer layer by electropolymerization using the first conductive polymer layer as an electrode. The conductive polymer layer 5 is preferably formed also on the surfaces of the pores in the inside of the anode 2.

A carbon layer 6a is formed on the portion of the conductive polymer layer 5 lying over the outside surfaces of the anode 2, and a silver layer 6b is formed on the carbon layer 6a. The carbon layer 6a can be formed by applying a carbon paste to the conductive polymer layer 5. The silver layer 6b can be formed by applying a silver paste to the carbon layer 6a. The carbon layer 6a and the silver layer 6b constitute a cathode layer 6.

A cathode terminal 9 is connected to the surface of the silver layer 6b through a conductive adhesive layer 7. On the other hand, an anode terminal 8 is connected to the anode lead 1. A molded resin outer package 10 is formed so that the ends of the anode and cathode terminals 8 and 9 are extended to the outside.

In the above manner, the solid electrolytic capacitor of this embodiment is formed.

FIG. 2 is a schematic cross-sectional view showing in enlarged dimension the surface and adjacent region of the anode 2 of the solid electrolytic capacitor shown in FIG. 1.

As shown in FIG. 2, the anode 2 is a porous body and has fine pores formed in the inside thereof. The dielectric layer 3 is formed on the anode 2, and the polyvinyl alcohol film 4 is formed on the dielectric layer 3.

In the present invention, the polyvinyl alcohol film 4 having a cross-linked structure is provided on the dielectric layer 3. The provision of the polyvinyl alcohol film 4 enables the reduction of a leakage current flowing between the anode 2 and the cathode layer 6 even under conditions of voltage application. In addition, even at high temperatures or upon voltage application to the load, the occurrence of a short circuit due to the generation of avalanche current can be prevented to increase the withstand voltage of the capacitor.

A detailed mechanism providing the above-described effects of the present invention is not completely clear but can be assumed as follows.

If defects exist in the dielectric layer, a current, although very small, flows through the dielectric layer upon voltage application, which causes a leakage current. If the leakage current becomes large, a short circuit occurs. In the present invention, the polyvinyl alcohol film, which is an insulator, is formed between the dielectric layer and the conductive polymer layer. In addition, since the polyvinyl alcohol layer has a cross-linked structure, it exhibits excellent electrical insulation. For these reasons, it can be considered that the surfaces of defect sites in the dielectric layer can be coated with the polyvinyl alcohol film having excellent electrical insulation. Therefore, it can be assumed that the leakage current can be reduced, the occurrence of a short circuit due to increased leakage current can be prevented, and the withstand voltage can be increased.

Furthermore, the polyvinyl alcohol film is formed on the dielectric layer. Because polyvinyl alcohol has a surface-active effect, it can be assumed that polyvinyl alcohol enters deep into the porous body serving as an anode to provide more excellent electrical insulation.

### Second Embodiment

Next, a description will be given of a solid electrolytic capacitor of a second embodiment. Further explanation of the same elements as in the first embodiment described above will be omitted.

In this embodiment, the polyvinyl alcohol film 4 contains a second conductive polymer. A conductive polymer layer 5 containing a first conductive polymer is formed on the polyvinyl alcohol film 4 containing the second conductive polymer. Since the polyvinyl alcohol film 4 contains the second conductive polymer, the withstand voltage can be further increased to further reduce the leakage current. In addition, the capacitance can be increased.

The second conductive polymer may be of the same type as or a different type from the first conductive polymer. When the conductive polymer layer 5 is formed of plural types of first conductive polymers, the second conductive polymer may be of the same type as at least one of the plural types of first conductive polymers or of a different type from all the types of first conductive polymers.

An example of a method for containing the second conductive polymer into the polyvinyl alcohol film 4 is as follows.

After the polyvinyl alcohol film 4 is formed in the same manner as described previously, the anode 2 is immersed into a liquid containing a monomer of the second conductive polymer to allow the polyvinyl alcohol film 4 to contain the monomer, and the anode 2 is then immersed into a solution of oxidizing agent to polymerize the monomer in the polyvinyl alcohol film 4, thereby forming the second conductive polymer.

Through the above process, the second conductive polymer can be contained in the polyvinyl alcohol film 4.

After the second conductive polymer is contained in the polyvinyl alcohol film 4 by chemical polymerization in the above manner, the conductive polymer layer 5 is formed in the same manner as in the first embodiment on the polyvinyl alcohol film 4 containing the second conductive polymer. Like the first embodiment, the conductive polymer layer 5 may be formed by sequentially forming a first conductive polymer layer and a second conductive polymer layer. In this embodiment, the oxidizing agent adheres to the surface of the polyvinyl alcohol film 4. Therefore, by bringing a vapor of the first conductive polymer forming the conductive polymer layer 5 into contact with the surface of the polyvinyl alcohol film 4, the first conductive polymer layer made of the first conductive polymer is formed on the polyvinyl alcohol film 4.

Note that although in this embodiment the first conductive polymer layer is formed directly on the polyvinyl alcohol film 4 containing the second conductive polymer, a conductive polymer layer containing the second conductive polymer may lie between the polyvinyl alcohol film 4 and the first conductive polymer layer.

A further detailed description will be given of the step of containing the second conductive polymer into the polyvinyl alcohol film 4.

The concentration of the monomer of the second conductive polymer in the liquid containing the monomer is preferably within the range of 1% to 100% by mass and more preferably within the range of 20% to 100% by mass. The concentration of the monomer is still more preferably within the range of 50% to 100% by mass and even more preferably within the range of 90% to 100% by mass. The preferred second conductive polymer for use is polypyrrole as described previously. Therefore, the preferred monomer for use is pyrrole.

It can be considered that in the polyvinyl alcohol film 4 having a cross-linked structure, pyrrole as a monomer is contained while having some kind of interaction with atoms in the cross-linked structure of polyvinyl alcohol, as shown in Formula 1 below, so that the monomer is placed inside the chain of the polyvinyl alcohol cross-linked structure. This can also be assumed from the fact that when opaque polyvinyl alcohol particles in the aqueous solution of oxidizing agent, i.e., polyvinyl alcohol particles having made the aqueous solution cloudy, is immersed into a solution of 100% pyrrole, they are turned into transparent particles.

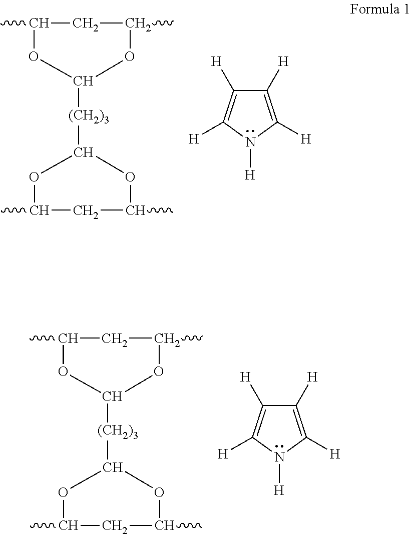

After pyrrole as a monomer is contained in the polyvinyl alcohol film 4, the polyvinyl alcohol film 4 is brought into contact with a solution containing an oxidizing agent, so that pyrrole in the polyvinyl alcohol film 4 can be polymerized to form polypyrrole.

Examples of the oxidizing agent include protonic acids, such as hydrochloric acid, sulfuric acid, hydrofluoric acid, perchloric acid, trichloroacetic acid, trifluoroacetic acid, and phosphoric acid; and transition metal halides, such as peroxides, halogens, and iron chloride.

Although no particular limitation is placed on the concentration of oxidizing agent in the solution of oxidizing agent, it can be within the range of 0.5 to 20 mol/L, for example. No particular limitation is also placed on the temperature of the solution of oxidizing agent; for example, the temperature is preferably within the range of 1° C. to 90° C. and more preferably within the range of 1° C. to 70° C. The temperature of the solution of oxidizing agent is appropriately selected depending upon the types of monomer and oxidizing agent used.

The monomer of the second conductive polymer contained in the polyvinyl alcohol film may not necessarily be fully polymerized and unreacted monomer may be left in the polyvinyl alcohol film 4.

In the second embodiment, an anode with a dielectric layer and a cross-linked polyvinyl alcohol film sequentially formed thereon is immersed into a solution containing a monomer, so that a conductive polymer can be efficiently contained in the entire polyvinyl alcohol film extending from the outside surfaces of the anode to the surfaces of pores in the inside of the anode in the form of a porous body. Therefore, the reduction in capacitance due to the polyvinyl alcohol film can be further reduced.

Examples of the first conductive polymer forming the conductive polymer layer 5 in the present invention include polypyrrole, polythiophene, polyethylenedioxythiophene, and polyaniline. Alternatively, the first conductive polymer used may be a polymer dispersion in which polymer particles with a nanometer-scale particle size are dispersed in a dispersion medium, such as water or an organic solvent.

On the other hand, examples of the second conductive polymer contained in the polyvinyl alcohol film 4 include the same polymers as those described above for the first conductive polymer. Of these, the particularly preferred is polypyrrole.

### EXAMPLES

Hereinafter, the present invention will be described with reference to specific examples. However, the present invention is not limited to the following examples.

### Experiment 1

### Example 1

(Step 1)

A tantalum metal powder (with an average particle diameter of approximately 0.5 μm) was used as a valve metal powder to form it, with a tantalum-made anode lead embedded therein, into a formed body and then sinter the formed body in vacuum, thereby producing a sintered tantalum element as an anode.

The sintered tantalum element was immersed into a 0.05% by mass aqueous solution of phosphoric acid and a constant voltage of 10 V was applied to the sintered tantalum element in the solution to anodize the anode, so that a dielectric layer was formed on the surface of the anode.

(Step 2)

Polyvinyl alcohol (PVA) was dissolved in pure water to give a concentration of 0.05% by mass, thereby preparing an aqueous solution of PVA. The anode with the dielectric layer formed thereon was immersed into the aqueous solution of PVA. Thereafter, the anode was picked up from the aqueous solution of PVA and dried to sufficiently remove the solvent, so that a PVA film was formed on the surface of the dielectric layer.

(Step 3)

An aqueous solution of glutaraldehyde was prepared in which glutaraldehyde serving as a cross-linking agent was dissolved in pure water to give a concentration of 0.56 M (mol/L). The anode with the PVA film formed thereon was immersed into the aqueous solution, then picked up from it, and allowed to stand for 30 minutes to cross-link the PVA film. Thereafter, the anode was dried and then immersed into pure water to rinse the surface of the PVA film with the pure water, thereby removing unreacted PVA and glutaraldehyde. Thus, the PVA film having a cross-linked structure was formed on the dielectric layer of the anode.

The thickness of the PVA film was measured with a transmission electron microscope (TEM). The thickness of the PVA film was 5 nm.

The measurement of the thickness of the PVA film by TEM observation was performed in the following manner. The anode was cut at the center thereof in parallel with the direction of the anode lead, and in the cut surface thereof the thickness of the PVA film on the dielectric layer in the vicinity of the anode lead was measured.

(Step 4)

Next, two conductive polymer layers made of polypyrrole were formed on the PVA film, first by chemical polymerization and then by electropolymerization or otherwise.

A carbon paste and a silver paste were applied in this order to the outside surfaces of the anode with the conductive polymer layers formed thereon to form a cathode layer, thereby producing a capacitor element.

(Step 5)

The capacitor element was put on a lead frame terminal, and the anode lead and cathode layer of the capacitor were bonded to the frame terminal.

(Step 6)

Next, the capacitor element and the lead frame terminal were encapsulated in an epoxy molding resin to produce a solid electrolytic capacitor.

### Example 2

In place of glutaraldehyde, boric acid was used as a cross-linking agent. Boric acid was dissolved in pure water to give a concentration of 5% by mass, thereby preparing an aqueous solution of boric acid. In Step 3 of Example 1, the aqueous solution of boric acid was used in place of the aqueous solution of glutaraldehyde. The anode was immersed into the aqueous solution of boric acid and then subjected to a heat treatment at 175° C. for 10 minutes to form a cross-linked structure in the PVA film. In the same manner as in Example 1 for the rest, a solid electrolytic capacitor was produced. The thickness of the PVA film was 5 nm.

### Comparative Example 1

A solid electrolytic capacitor was produced in the same manner as in Example 1, except that Step 3 of Example 1 was not performed. Therefore, in this comparative example, an uncross-linked PVA film was provided between the dielectric layer and the conductive polymer layer. The thickness of the PVA film was 5 nm.

[Evaluation of Solid Electrolytic Capacitors]

Each of the solid electrolytic capacitors produced in the above manners was measured in terms of leakage current and withstand voltage. Each measured value is an average value from 100 capacitor elements for each example.

The leakage current was measured five minutes after the application of a rated voltage at room temperature. The withstand voltage is a voltage at which a short circuit occurs to allow a rush current to flow through the capacitor as the voltage applied thereto is changed stepwise from 1 V to 10 V. The measurement results are shown in TABLE 1. In TABLE 1, the values of the leakage current and withstand voltage are indicated by indices when each of the leakage current and voltage resistance of Comparative Example 1 is taken as 100.

TABLE 1

| | PVA Concentration | | Withstand | Leakage |
|---|---|---|---|---|
| | (% by mass) | Cross-liking Agent | Voltage | Current |
| Ex. 1 | 0.05 | Glutaraldehyde | 145 | 50 |
| Ex. 2 | 0.05 | Boric Acid | 110 | 90 |
| Ex. 3 | 0.05 | — | 100 | 100 |

As shown in TABLE 1, the solid electrolytic capacitors of Examples 1 and 2 of the present invention are reduced in leakage current and increased in withstand voltage, compared to the solid electrolytic capacitor of Comparative Example 1. Particularly, Example 1 employing glutaraldehyde as a cross-linking agent is reduced in leakage current and increased in withstand voltage to a greater extent than Example 2 employing boric acid as a cross-linking agent. It can be seen from this that aldehyde compounds, such as glutaraldehyde, are more preferred as cross-linking agents than boric acid. It can be considered that when boric acid was used as a cross-linking agent, heat application for a cross-linking reaction must be performed at 175° C., which imposed an excessive heat load on the dielectric layer to damage it, resulting in smaller reduction in leakage current and smaller increase in withstand voltage.

### Example 3

A solid electrolytic capacitor was produced in the same manner as in Example 1, except that the concentration of the PVA solution was 0.1% by mass. The thickness of the PVA film was 10 nm.

### Example 4

A solid electrolytic capacitor was produced in the same manner as in Example 1, except that the concentration of the PVA solution was 0.2% by mass. The thickness of the PVA film was 20 nm.

### Example 5

A solid electrolytic capacitor was produced in the same manner as in Example 1, except that the concentration of the PVA solution was 0.5% by mass. The thickness of the PVA film was 50 nm.

### Example 6

A solid electrolytic capacitor was produced in the same manner as in Example 1, except that the concentration of the PVA solution was 0.02% by mass. The thickness of the PVA film was 2 nm.

[Evaluation of Solid Electrolytic Capacitors]

Each of the resultant solid electrolytic capacitors was measured in terms of leakage current and withstand voltage in the same manners as described above. The measurement results are shown in TABLE 2.

TABLE 2

| | Thickness | | | |
|---|---|---|---|---|
| | of PVA | | Withstand | Leakage |
| | Film (nm) | Cross-linking Agent | Voltage (V) | Current (mA) |
| Ex. 6 | 2 | Glutaraldehyde | 6.4 | 0.22 |
| Ex. 1 | 5 | Glutaraldehyde | 9.0 | 0.13 |
| Ex. 3 | 10 | Glutaraldehyde | 8.8 | 0.15 |
| Ex. 4 | 20 | Glutaraldehyde | 8.5 | 0.16 |
| Ex. 5 | 50 | Glutaraldehyde | 6.5 | 0.22 |

As is evident from the results shown in TABLE 2, it can be seen that when the thickness of the PVA film is within the range of 5 to 20 nm, the leakage current can be further reduced and the withstand voltage can be further increased. Therefore, it can be seen that the thickness of the PVA film is preferably within the range of 5 to 20 nm and more preferably within the range of 5 to 10 nm.

### Experiment 2

### Example 7

After the formation of the PVA film having a cross-linked structure in Example 1, the anode was immersed into a 100% by mass pyrrole liquid. Next, the anode was immersed into a solution of oxidizing agent for 10 minutes. Thus, pyrrole impregnated in the PVA film was polymerized to form polypyrrole in the PVA film.

After immersed into the solution of oxidizing agent, the anode was picked up and exposed to a vapor of pyrrole to polymerize the pyrrole by gas-phase chemical polymerization, thereby forming a polypyrrole film serving as a first conductive polymer layer in a conductive polymer layer.

Thereafter, a second conductive polymer layer made of polypyrrole was formed on the first conductive polymer layer by electropolymerization.

### Example 8

A solid electrolytic capacitor was produced in the same manner as in Example 1. Specifically, the formation of a conductive polymer layer in Example 8 is as follows.

After the formation of the PVA film having a cross-linked structure, the anode was immersed into a solution of oxidizing agent of the same composition as that used in Example 1. Thereafter, the anode was picked up and dried. Next, the anode was exposed to a vapor of pyrrole to polymerize the pyrrole by gas-phase chemical polymerization, thereby forming a polypyrrole film as a first conductive polymer layer. Subsequently, the polypyrrole film was used as an electrode to form a polypyrrole film as a second conductive polymer layer by electropolymerization.

The resultant solid electrolytic capacitor was similar to that of Example 1.

### Comparative Example 2

A solid electrolytic capacitor was produced in the same manner as in Example 1, except that the PVA film having a cross-linked structure was not formed and the conductive polymer layer was formed directly on the dielectric layer.

### Comparative Example 3

In Example 1, a polypyrrole film, in place of the PVA film having a cross-linked structure, was formed on the dielectric layer. Specifically, after the formation of the dielectric layer, the anode was immersed into a 100% by mass pyrrole liquid and then immersed into a solution of oxidizing agent to form a polypyrrole film by chemical polymerization. Thereafter, a conductive polymer layer was formed on the polypyrrole film in the same manner as in Example 1.

[Evaluation of Solid Electrolytic Capacitors]

Each of the resultant solid electrolytic capacitors was measured in terms of leakage current and withstand voltage in the same manners as described above.

Each of the resultant solid electrolytic capacitors was also measured in terms of capacitance. The capacitance was measured by applying an alternating voltage of 100 my at 120 Hz between the electrodes.

The measurement results are shown in TABLE 3.

TABLE 3

| | Withstand | | |
|---|---|---|---|
| | Voltage (V) | Leakage Current (mA) | Capacitance (uF) |
| Ex. 7 | 12.0 | 0.10 | 70 |
| Ex. 8 | 9.0 | 0.13 | 60 |
| Comp. Ex. 2 | 6.2 | 0.25 | 80 |
| Comp. Ex. 3 | 6.3 | 0.24 | 78 |

As shown in TABLE 3, Example 7 in which polypyrrole was contained in the PVA film having a cross-linked structure was further increased in withstand voltage and further reduced in leakage current, compared to Example 8 in which no polypyrrole is contained in the PVA film having a cross-linked structure. The reason for this can be explained as follows: Because polypyrrole as a second conductive polymer contained in the PVA film covers the surface of the dielectric layer in a uniform and well-adhering manner, the self-repairability of the dielectric layer due to polypyrrole is increased, so that the reduction in leakage current and increase in withstand voltage can be further improved.

Furthermore, Example 7 is increased in capacitance compared to Example 8. As is evident from comparison between Example 8 and Comparative Example 2, when a PVA film having a cross-linked structure is formed, the capacitance is reduced because the PVA film having a cross-linked structure is an insulating material. However, when, like Example 7, polypyrrole is contained in a PVA film having a cross-linked structure, the reduction in capacitance can be reduced. The reason for this can be that the inclusion of electrically conductive polypyrrole in the PVA film reduces the insulating properties of the PVA film.

Furthermore, as is evident from TABLE 3, Examples 7 and 8 are excellent in withstand voltage characteristic and reduced in leakage current, compared to Comparative Examples 2 and 3.

1. A solid electrolytic capacitor including an anode, a dielectric layer formed on the anode, a polyvinyl alcohol film formed on the dielectric layer, and a conductive polymer layer formed on the polyvinyl alcohol film,
wherein the polyvinyl alcohol film has a cross-linked structure.

2. The solid electrolytic capacitor according to claim 1, wherein the cross-linked structure of the polyvinyl alcohol film is formed by a cross-linking agent having at least two aldehyde groups, at least two hydroxyl groups, or at least two carboxyl groups.

3. The solid electrolytic capacitor according to claim 2, wherein the cross-linking agent is glutaraldehyde.

4. The solid electrolytic capacitor according to claim 1, wherein the thickness of the polyvinyl alcohol film is within the range of 5 to 20 nm.

5. The solid electrolytic capacitor according to claim 1, wherein the polyvinyl alcohol film contains a second conductive polymer separate from a first conductive polymer forming the conductive polymer layer.

6. The solid electrolytic capacitor according to claim 5, wherein the second conductive polymer is polypyrrole.

7. A method for manufacturing the solid electrolytic capacitor according to claim 1, the method comprising the steps of:
producing the anode;
forming the dielectric layer on the anode;
immersing the anode with the dielectric layer formed thereon into a solution of polyvinyl alcohol to allow polyvinyl alcohol to adhere to the dielectric layer;
after the adhesion of the polyvinyl alcohol, immersing the anode into a solution containing a cross-linking agent to cross-link the polyvinyl alcohol and thereby form the polyvinyl alcohol film having a cross-linked structure on the dielectric layer; and
forming the conductive polymer layer on the polyvinyl alcohol film.

8. The method according to claim 7 for manufacturing the solid electrolytic capacitor according to claim 5, further comprising the steps of:
after the formation of the polyvinyl alcohol film, immersing the anode into a liquid containing a monomer of the second conductive polymer to allow the polyvinyl alcohol film to contain the monomer; and
after the inclusion of the monomer in the polyvinyl alcohol film, immersing the anode into a solution of oxidizing agent to polymerize the monomer in the polyvinyl alcohol film and thereby form the second conductive polymer.

9. The method according to claim 7, wherein the concentration of the solution of polyvinyl alcohol is within the range of 0.05% to 0.2% by mass.
